(19) United States
(12) Patent Application Publication
(10) Pub. No.: US 2022/0225569 A1
(43) Pub. Date: Jul. 21, 2022

(54) Apparatus, Systems, And Methods For Row Crop Headers

(71) Applicant: Ag Leader Technology, Ames, IA (US)

(72) Inventors: Roger Zielke, Huxley, IA (US); Scott Eichhorn, Ames, IA (US); Alan F. Barry, Nevada, IA (US); Cody Sobotka, Ames, IA (US); Jonathan Brand, Ames, IA (US)

(21) Appl. No.: 17/576,463

(22) Filed: Jan. 14, 2022

Related U.S. Application Data
(60) Provisional application No. 63/137,946, filed on Jan. 15, 2021.

(51) Int. Cl. A01D 45/02; A01D 57/22

(52) U.S. Cl. CPC A01D 45/021; A01D 57/22

(57) ABSTRACT

A crop header adjustment system including a plurality of row units, a plurality of dividers disposed between the row units, a plurality of pitch adjustment mechanisms operatively engaged with each of the plurality of dividers, and a controller in communication with the each of the plurality of pitch adjustment mechanisms. The controller configured to adjust the pitch of the plurality of the dividers on-the-go in response to changing conditions.

### CROSS-REFERENCE TO RELATED APPLICATION(S)

This application claims the benefit under 35 U.S.C. § 119(e) to U.S. Provisional Application 63/137,946, filed Jan. 15, 2021, and entitled “Apparatus, Systems, and Methods for Row Crop Headers,” which is hereby incorporated herein by reference in its entirety for all purposes.

### TECHNICAL FIELD

The disclosure relates to row crop headers equipped with row dividers and associated adjustment systems.

### BACKGROUND

As would be appreciated, row crop headers, such as corn heads, are used by harvesters to gather crops grown in rows. Row dividers (also referred to as “snouts” or “snoots”) protrude between rows and guide stalks into the crop header. During harvest an operator may periodically make decisions on how to adjust the height of the crop header as well the angle of the row dividers. Various factors may influence this decision making, such as the condition of the crop, the condition and composition of the ground itself, and the local topography.

On various known crop headers, row dividers are attached to the row header at a pivot point. On some known crop headers, an adjustable stop mechanism holds the row dividers at a desired pitch or angle relative to the crop header. In certain of these known crop headers, the row dividers are free to float above the stop if something, such as the ground or debris, pushes the row divider up. Many different stop mechanism designs are known in the art. Various of these known designs must be manually adjusted.

FIGS. 1 and 2 show a prior art snout 2 and stop mechanism 4. In this prior art design, the snout stop 6 pivots around an axle 8. The orientation of the snout stop 6 can be set by seating a spring-loaded pin into one of four corresponding slots on the snout stop 6, where each slot corresponds to a different height setting, as would be understood.

Further, various corn header height control systems are known in the art for maintaining a header at a target height. These known systems use a header height sensor mounted under one or more snouts 2 to sense and adjust header height. In certain other known implementations, the operator may manually adjust the header height.

There is a need in the art for improved crop header adjustment systems, devices, and methods.

### BRIEF SUMMARY

Disclosed herein are various crop header adjustment systems, including systems for determining when and how adjustments to a crop header should be made and the magnitude of such adjustments. In #3342029 various implementations, adjustments include changes to the header height and/or the pitch or angle of the row dividers on the header.

In Example 1, a harvester adjustment system comprising: a database comprising one or more of rock locations, hazard locations, terrain obstacles and topography; at least one sensor configured to determine a crop condition; a processor in communication with the database and the at least one sensor; a header height adjustment mechanism in communication with the processor; and a plurality of row divider adjustment mechanisms disposed on each row divider of a harvester, in communication with the processor, wherein the processor is configured to adjust the header height and the row divider angle based upon data from the database and sensed crop condition.

Example 2 relates to the harvester adjustment system of Example 1, wherein the plurality of row dividers are adjusted on a row-by-row basis.

Example 3 relates to the harvester adjustment system of Example 1, wherein a target header height and a target row divider position are inputted into the processor.

Example 4 relates to the harvester adjustment system of Example 3, further comprising a header height sensor in communication with the processor and configured to determine an actual header height.

Example 5 relates to the harvester adjustment system of Example 4, wherein the actual header height is compared to the target header height and the header height is adjusted so that the actual header height is within deadband of the target header height.

Example 6 relates to the harvester adjustment system of Example 4, wherein no adjustment to the header height is made if the actual header height is within deadband of the target header height.

Example 7 relates to the harvester adjustment system of Example 3, further comprising a row divider sensor in communication with the processor and configured to determine an actual row divider position.

Example 8 relates to the harvester adjustment system of Example 7, wherein the actual row divider position is compared to the target row divider angle and the row divider angle is adjusted so that the actual row divider position is within deadband of the target row divider position.

Example 9 relates to the harvester adjustment system of Example 7, wherein no adjustment to the row divider angle is made if the actual row divider position is within deadband of the target row divider position.

In Example 10, a method for adjusting harvester orientation comprising: entering a target row divider tip height; determining an actual row divider tip height from a row divider sensor; comparing the actual row divider tip height to the target row divider tip height and determining if the actual row divider tip height is approximately the target row divider tip height; and outputting a signal to a row divider adjustment mechanism to urge the row divider to an angle where the row divider tip is approximately the target row divider tip height.

Example 11 relates to the method of Example 10, wherein the row divider sensor is an angle sensor or a height sensor.

Example 12 relates to the method of Example 11, wherein the height sensor is an ultrasonic sensor or a time-of-flight sensor.

Example 13 relates to the method of Example 10, wherein the method is conducted iteratively and the row divider tip height is adjusted on-the-go.

Example 14 relates to the method of Example 10, wherein no adjustment to the row divider tip height is made if the row divider tip height is approximately the target row divider tip height.

Example 15 relates to the method of Example 10, wherein the target row divider tip height is based upon one or more of crop condition, ground condition, and topography.

Example 16 relates to the method of Example 10, further comprising: entering a target header height into a processor; determining an actual header height from a header height sensor; comparing the actual header height to the target header height and determining if the actual header height is approximately the target header height; and outputting a signal to a header height adjustment mechanism to move the header to a height that is approximately the target header height.

Example 17 relates to the method of Example 16, wherein the header height sensor is an ultrasonic sensor or time-of-flight sensor.

Example 18 relates to the method of Example 16, wherein no adjustment to the header height is made if the header height is approximately the target header height.

Example 19 relates to the method of Example 16, wherein the method is conducted iteratively and the header height and the row divider tip height are adjusted on-the-go.

In Example 20, a method of adjusting a row divider angle, comprising: entering a target row divider tip height; entering a target header height; determining an actual row divider tip height from a row divider sensor; determining an actual header height from a header height sensor; comparing the actual row divider tip height to the target row divider tip height and determining if the actual row divider tip height is the target row divider tip height; comparing the actual header height to the target header height and determining if the actual header height is the target header height; and outputting one or more signals to a row divider adjustment mechanism and a header height adjustment mechanism to move the header and urge the row divider to positions where the row divider tip and header are at the target row divider tip height and target header height, wherein the method is conducted iteratively and the row divider tip height and header height are adjusted on-the-go.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a known row divider and snout stop, according to one implementation.

FIG. 2 shows a known row divider and snout stop, according to one implementation.

FIG. 3A is an image of healthy corn crops with erect ears, according to one implementation.

FIG. 3B is an image of drought stressed corn crops with droopy ears, according to one implementation.

FIG. 4 is an image of two corn field having crops at different heights, according to one implementation.

FIG. 5 is an image of downed crops, according to one implementation.

FIG. 6 is an image of goose-necked corn crops, according to one implementation.

FIG. 7 is an image of a rock colliding with a harvester row unit, according to one implementation.

FIG. 8 is an image of a grass waterway in a field, according to one implementation.

FIG. 9 is an image of a terraced field, according to one implementation.

FIG. 10A is a top view of a harvester, according to one implementation.

FIG. 10B is a schematic view of harvester and adjustment systems, according to one implementation.

FIG. 11 is a flow diagram for adjustment of header height, according to one implementation.

FIG. 12 is a flow diagram for adjustment of header height and/or row divider angle, according to one implementation.

FIG. 13A is a side view of a row divider with an actuator adjustment mechanism, according to one implementation.

FIG. 13B is a side view of the row divider of FIG. 13A in a raised position, according to one implementation.

FIG. 14A is a side view of a row divider with an actuator adjustment mechanism, according to one implementation.

FIG. 14B is a side view of the row divider of FIG. 14A in a raised position, according to one implementation.

FIG. 15A is a side view of a row divider with a cable and winch adjustment mechanism, according to one implementation.

FIG. 15B is a side view of the row divider of FIG. 15A in a raised position, according to one implementation.

FIG. 16A is a side view of a row divider with a ground contacting adjustment mechanism, according to one implementation.

FIG. 16B is a side view of a row divider with a ground contacting member having actuator adjustment mechanism, according to one implementation.

FIG. 16C is a side view of a row divider with a ground contacting member having a winch and cable adjustment mechanism, according to one implementation.

FIG. 16D is a side view of a ground contacting member having skids, according to one implementation.

FIG. 16E is a side view of a ground contacting member having discs, according to one implementation.

FIG. 17A is a side view of a row divider having a height sensor and an angle sensor, according to one implementation.

FIG. 17B is a side view of the row divider of FIG. 17A in a raised position, according to one implementation.

FIG. 18A is a side view of a row divider having a height sensor, according to one implementation.

FIG. 18B is a side view of the row divider of FIG. 18A in a raised position, according to one implementation.

FIG. 19 is a flow diagram for operation of the system, according to one implementation.

FIG. 20 is a flow diagram for operation of the system, according to one implementation.

FIG. 21 is a flow diagram for operation of the system, according to one implementation.

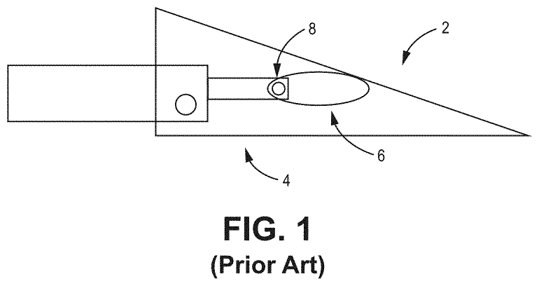

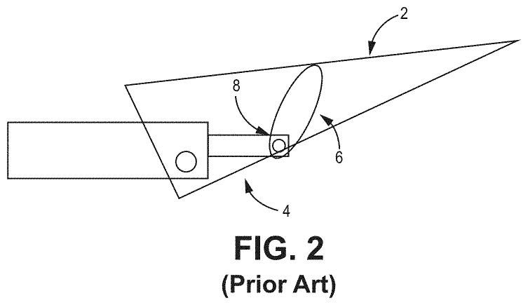

### DETAILED DESCRIPTION

Various devices, systems, and methods disclosed and/or contemplated herein relate to crop header adjustment systems, including systems for determining when and how adjustments to a crop header should be made, and the magnitude of such adjustments. In various implementations, adjustments include adjustments to the header height and/or the pitch or angle of the row dividers on the header.

In various implementations, a harvester utilizes one or more sensors and/or stored data to provide information to a system and/or operator to make decisions regarding crop header height and/or row divider pitch or angle. The data from the various sensors may then be used for manual or automatic adjustments to the crop header height and/or row divider pitch/angle. In various implementations, adjustments are made during harvest operations, on-the-go.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. Pat. No. 11,064,653, issued Jul. 20, 2021, entitled “Agricultural Systems Having Stalk Sensors and/or Data Visualization Systems and Related Devices and Methods,” U.S. patent application Ser. No. 16/800,469, filed Feb. 25, 2020, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021 and entitled “Apparatus, Systems and Methods for Stalk Sensing,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. Patent Application 63/176,408, filed Apr. 19, 2021, entitled “Automatic Steering Systems and Methods,” U.S. Patent Application 63/186,995, filed May 11, 2021, entitled “Calibration Adjustment for Automatic Steering Systems,” and U.S. Patent Application 63/241,393, filed Sep. 7, 2021, entitled “Row-by-Row Estimation System and Related Devices and Methods,” each of which is incorporated by reference herein.

As would be appreciated, snouts can bend or break if the snout tips collide with uneven terrain such as gullies and terraces or with various other hazards (e.g. tree limbs, dense weeds, rocks, etc.). As is also appreciated snout tips are typically set to run just above the soil surface during harvest, typically about 2 to 12 inches above the soil surface. Further, some row dividers may be angled towards the soil surface. As such it is critical to provide devices, systems, and methods for controlling header height and/or row divider pitch such that harvest operations are optimized while minimizing potential damage to the header or its components.

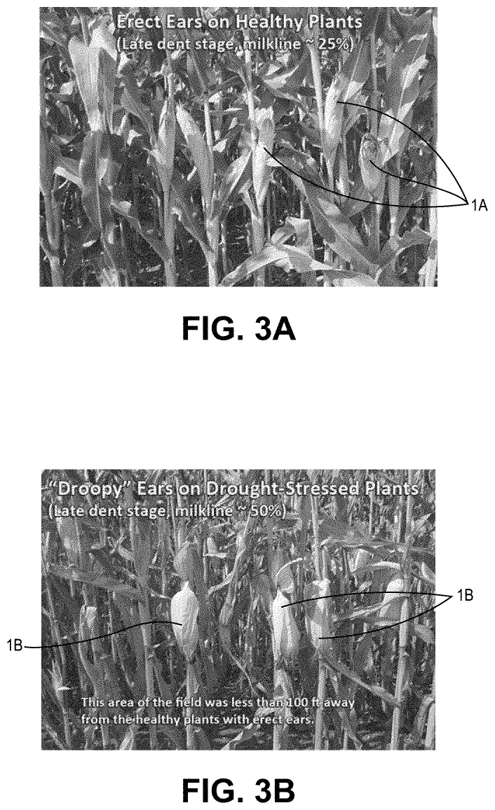

As would be understood, optimal crop header height and row divider angle depend on a variety of factors, such as but not limited to crop condition, ground condition and composition, and topography. As shown in FIGS. 3A and 3B, corn ears 1 may be erect (shown at 1A) or corn ears 1 may be droopy (shown at 1B). As would be appreciated by those of skill in the art various factors can influence if corn ears 1 are erect 1A or droopy 1B including, but not limited to, plant health, moisture, maturity, and soil conditions. If the corn ears 1 are droopy 1B the crop headers may need to be lowered and/or the row dividers angled downward for proper harvesting. That is, in a field or portion of a field with droopy ears 1B the header may be lowered such that the ears 1 are harvested without (or with minimal) loss of kernels, improving overall yield. It would also be understood by those of skill, that in a single field both conditions—erect 1A and droopy 1B—may exist in close proximity.

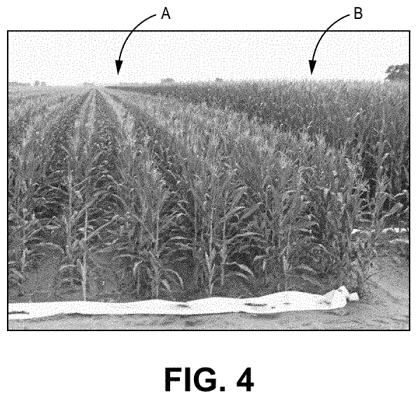

Further, various corn plants reach maturity at different times or may be at a lower height at the point of maturity, as shown in FIG. 4. In FIG. 4, the corn plants in field A are shorter than the corn plants in field B. This difference in crop height may be attributable to a difference in plant variety, time to maturity, and/or other appreciated factors. The corn header height and/or row divider angle may require adjustment depending on the height of the plants at harvest.

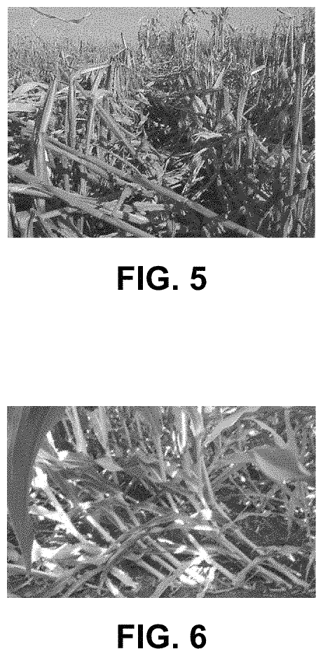

A further exemplary crop condition is the orientation or condition of the corn plants themselves. As shown in FIG. 5, crops may be “lodged” or “downed”, for example, because of bent or broken stalks. FIG. 6 shows goosenecked corn, which may result from a plant being blown over or otherwise flattened at some point in the growing season but continuing thereafter to grow vertically. The damaged or goosenecked crops may still have productive ears to be harvested. In these situations, the crop header may need to be adjusted to be lower to the soil to efficiently harvest crops with these conditions. Additionally or alternatively, a row divider may be angled towards the soil to pass under and lift stalks from the soil for harvesting. As would be appreciated, the ability to efficiently harvest this type of damaged crop can improve overall crop yield in a field that may otherwise have been a loss or had major losses.

As noted above, the ground condition, composition, and/or topography may also influence the proper, ideal crop header height and row divider pitch/angle. Provided herein are devices, systems, and methods for monitoring and controlling header height and/or row divider pitch such that harvest operations are optimized while minimizing potential damage to the header or its components.

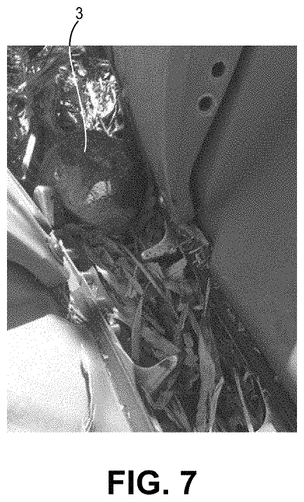

For example, a field may contain various hazards such as rocks 3, shown in FIG. 7. As would be understood medium or large rocks 3 may become lodged in a crop header during harvest operations. Such rocks 3 or similar hazards may cause equipment damage and loss of productivity. In one example, the crop header and/or row dividers may be lifted to avoid collisions with rocks 3. Hazards, such as rocks, may be detected in real-time or near real-time, identified from aerial imagery, and/or detected by other vehicles travelling through the field at earlier times and recording the locations of the hazards, such as described in U.S. application Ser. Nos. 17/170,752, 16/216,457, and 13/421,659 which are incorporated herein by reference.

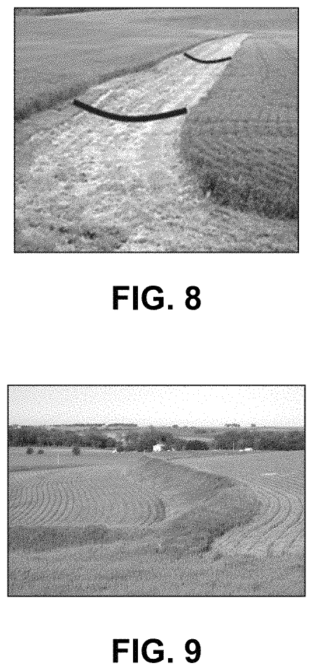

As would be understood, rolling and/or hilly topography may increase the chance of a row divider becoming lodged in the ground and being bent or broken as the harvester pitches up and down over the terrain. Certain terrain characteristics such as grass waterways, shown in FIG. 8, and terraced fields, shown in FIG. 9, may also cause a row divider tip to become lodged in the soil and potentially damaged if, for example, a harvester traverses this type of terrain with the row divider tips oriented too close to the soil.

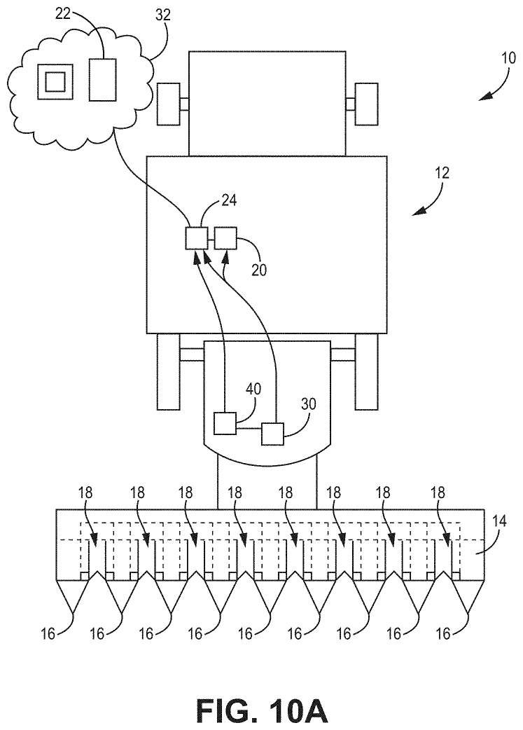

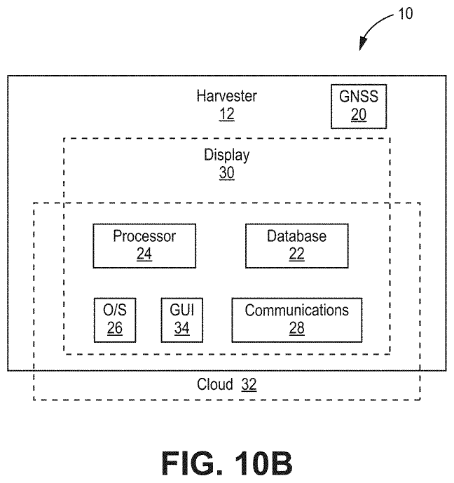

Turning to FIG. 10A, in various implementations, an adjustment system 10 is implemented on a harvester 12 to dynamically adjust the header 14 height and/or row divider 16 pitch in response to changing conditions, including those described above, as well as others, as would be appreciated by those of skill in the art. The harvester 12 may include a crop header 14 including a plurality of row units 18. In various implementations, the row units 18 are separated by row dividers 16, as would be understood. A variety of harvester 12 configurations are possible as would be understood by those of skill in the art.

Various of the above-described crop and ground conditions may be measured before and/or during harvest operations. The adjustment system 10 may include one or more sensors such as, but not limited to, mechanical sensors, video cameras, LIDAR sensors, time-of-flight imaging sensors, stereo camera depth sensors, structed light sensors, ultrasonic sensors, and other such sensors, as would be appreciated. Various implementations may include free and/or tethered drones or other aerial vehicles implementing one or more sensors to measure crop and ground conditions.

Certain crop and ground conditions may be measured directly, such as plant height among others. Various other crop and ground conditions may be derived from sensor data through various identification and classification techniques, as would be understood.

Still further implementations may use aerial or satellite imagery to detect crop and/or ground conditions. In these and other implementations, the system 10 may implement various image recognition and processing techniques to identify crop and ground conditions. For example, overhead imagery may be used to identify terraces and/or grass waterways. In another example, topographical maps and/or soil type maps may be used to identify ground conditions.

Various machine learning and/or artificial intelligence techniques and processes may be implemented to identify crop and ground conditions. For example, the system 10 may use convolution neural networks to process various sensor data including but not limited to aerial imagery from drones or satellites.

Continuing with FIGS. 10A-B, the system 10 may be constructed and arranged to make adjustments to the header 14 height and/or divider 16 angle on-the-go. Adjustments may be made in response to changing ground and/or crop conditions in real-time or near real time. In various implementations, both pre-recorded and real-time sensor data is synthesized by the adjustment system 10. This synthesized data may then be used by the system 10 to make appropriate adjustments to the header 14 and/or row divider 16.

In certain implementations, the various sensors and data therefrom may be used to generate maps and other data outputs for adjustments to the crop header 14 height and/or divider 16 angle. These maps and data may be integrated with various other agricultural mapping and navigation systems, as would be appreciated by those of skill in the art. Various mapping and navigation systems are disclosed in U.S. application Ser. Nos. 17/381,900, 17/369,876, 16/939,785, 16/921,828, 17/132,152, 63/176,408, and 63/186,995, each of which is incorporated by reference in its entirety. In various of these implementations, the harvester 12 includes a GNSS or GPS 20 for determining the location of the harvester 12 during harvest operations.

Continuing with FIGS. 10A-B, in various implementations the system 10 includes various hardware, software, and/or firmware components constructed and arranged to perform the operations and actions discussed herein, as would be readily appreciated. In certain implementations, the various processing and computing components necessary for the operation of the system 10, include components for receiving, recording, and processing the various received signals and imagery, generating the requisite calculations and commanding the various hardware, software, and firmware components necessary to effectuate the various processes described herein.

In certain implementations, system 10 comprises a processor 24 or central processing unit (CPU) 24 that is in communication with a non-volatile memory 22 or other data storage component 22 and an operating system 26 or software and sufficient media to effectuate the described processes. The processor 24 can be used with an operating system 26, a non-volatile memory 22/data storage 22, and the like, as would be readily appreciated by those of skill in the art. It is appreciated that in certain implementations, the data storage 22 and processor 24 can be local, such as on a display 30, the cloud 32, or some combination thereof, as would be understood.

In various implementations, the system 10 can comprise a circuit board, a microprocessor, a computer, or any other known type of processor 24 or CPU 24 that can be configured to assist with the operation of the system 10. In further embodiments, a plurality of CPUs 24 can be provided and may be operationally integrated with one another and various components of other systems on the vehicle 12 or used in connection with the vehicle 12 or agricultural operations, as would be appreciated. Further, it is understood that system 10 and/or its processors 24 can be configured via programming or software to control and coordinate the recordings from and/or operation of various sensors and data logging components, as would be readily appreciated.

Further implementations of the system 10 include a communications component 28, shown in FIG. 10B. The communications component 28 is configured for sending and/or receiving communications to and from one or more of row units 18, sensors, a GNSS 20, and the like, as would be appreciated.

In further implementations, the various components of the system 10 are housed within or otherwise are in operative communication with a display 30, such as the InCommand® display from Ag Leader®. In various implementations, the display 30 is located in the cab of the vehicle 12, as shown in FIG. 10A, but in alternative implementations the display 30 may also be located off-site and in communication with the vehicle 12 and sensors via a wireless connection, as would be understood. In various further implementations, certain components of the system 10 may be located remotely from the vehicle 12, such as in the cloud 32 or other server, as would be appreciated.

In further implementations, the display 30 optionally includes a graphical user interface (GUI) 34 and optionally a graphics processing unit (GPU). In these and other implementations, the GUI 34 and/or GPU allows for the display of information to a user and optionally for a user to interact with the displayed information, as would be readily appreciated. It would be understood that various input methods are possible for user interaction including but not limited to a touch screen, various buttons, a keyboard, or the like.

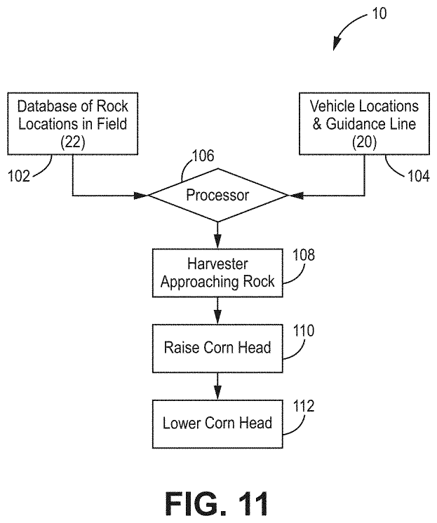

Turning to FIG. 11, in use, the system 10 may use various inputs to either raise or lower a corn head 14. In this specific example, the system 10 includes a database 22 of rock locations in a field (box 102), such as a database 22 with GPS coordinates for each hazardous rock in the field and optionally an approximate size/height of the rock(s). The system 10 may further use a GPS 20 or other navigation system to determine the vehicle 12 location in a field and/or the guidance line for the vehicle (box 104). In this implementation, the rock location database (102) and vehicle location and guidance path (box 104) are inputted into a processor 24 (box 106). The processor 24 (box 106) may then determine if the harvester 12 is approaching a rock or other hazard. When the processor 24 determines a harvester 12 is approaching a rock or other hazard (box 108) the processor 24 may output a command to raise the corn head 14 (box 110) or alternatively adjust the angle of the one or more row dividers 16 that may come in contact with the hazard. The corn head 14 may be raised (box 110) between 1 and 6 inches, or any other appropriate amount to clear the rock/hazard. The corn head 14 (box 112) or may optionally be lowered to a neutral position after the harvester 12 has passed over the rock 3. Alternatively, the dividers 16 may be returned to their neutral pitch/angle.

In certain implementations, as will be discussed further herein, the header 14 may be configured for individual row divider 16 control—row-by-row control—such that only the row dividers 16 in danger of colliding with the rock will be raised or adjusted while the remaining row dividers 16 will be maintained in their prior or neutral position. Alternatively, the row dividers 16 may be controller groups, such as sets of 3 or 4, as would be appreciated in light of this disclosure.

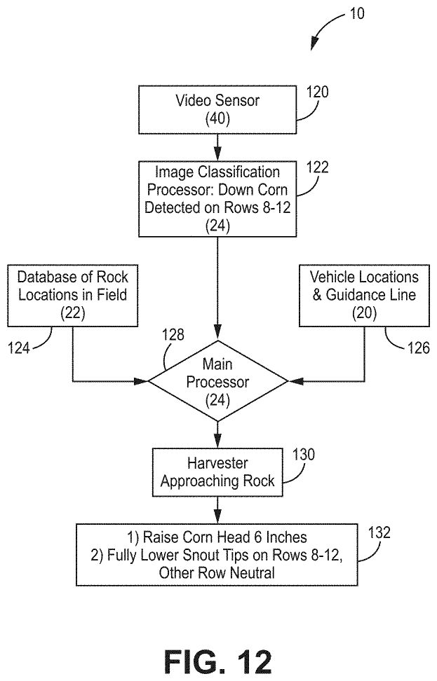

In another example, shown in FIG. 12, in use the system 10 may include inputs from one or more databases and/or real-time sensors. In these and other implementations, the system 10 includes a video sensor (shown at 40 in FIG. 10) (box 120) and an image classification processor (box 122). The video sensor 40 (box 120) may record images of the field during harvest such that the image classification processor (box 122) can process the recorded images to detect various ground conditions such as downed corn or other conditions, as would be understood. In certain implementations, the processed imagery is an input into a main or primary processor 24 (box 128). In certain implementations, the image classification processor and main/primary processor 24 are integral components or may be distinct devices. Other inputs may include a database 22 of rock and/or hazard locations (box 124) and vehicle locations and guidance lines (box 126) like those discussed above. Various other inputs are possible and would be recognized by those of skill in the art in light of this disclosure.

The main processor 24 (box 128) may then be constructed and arranged to use various techniques and devices such as, but not limited to, look-up tables, decision trees, weighted averages, neural networks, and machine learning to make decisions regarding the height of the corn head 14 and/or the angle of the dividers 16 (box 132). In various implementations, the machine learning algorithm is pre-trained on an existing data set and/or is trained by observing manual adjustments made by an operator during harvest, or any other known method of training as would be appreciated.

Continuing with FIG. 12, in various implementations, the system 10 recognizes through one or more of the outlined techniques and/or processes that the harvester 12 is approaching a rock, hazard, or changing ground or crop condition (box 130) and correspondingly adjusts the angle of the corn header 14 and/or row dividers 16 (box 132).

Adjustments (box 132) may be made in gross, to the entire header 14, on a row-by-row basis adjusting only the row divider(s) 16 encountering the hazard or changed condition, or on a basis of groups of row dividers 16. For example, if the harvester 12 is approaching a rock the entire header 14 may be raised about 6 inches. In another example, if only rows 8-12 contain downed corn only those rows dividers 16 will be lowered, while the remainder of the row dividers 16 are at their neutral position.

In various alternative implementations, the system 10 may be constructed and arranged to control the speed of the harvester 12. For example, it is common to operate the harvester 12 at slower than normal speed when harvesting downed plants. Various mechanisms for controlling speed are known and appreciated in the art.

In a further use case, it would be appreciated that damage and/or inefficiencies can occur if the row dividers 16 are run too far above the ground and/or the row dividers 16 are pitched too far down. In another example, if the header 14 is at the incorrect height such that the stalks rolls are too high and cut the stalk at ear level lost yield may occur. In this case, the stalk rolls will grab and shell the ears, leading to lost yield.

This type of stalk roll shelling can be reduced via the system 10 recognizing when stalk roll shelling is occurring and correspondingly lowering the header 14 height. In various implementations, the header 14 height may be adjusted downward to prevent stalk roll shelling while the row divider 16 tips are raised such as to maintain substantially constant ground to row divider 16 tip clearance. In various implementations, the system 10 incorporates a stalk roll shelling detection system, such as that disclosed in U.S. application Ser. Nos. 17/226,002, 17/225,586, and 17/225,740 which are hereby incorporated by reference.

Various additional reasons for adjusting header 14 height and/or row divider 16 angle are possible and are contemplated herein, and would be appreciated by those of skill in the art.

Various mechanisms are known for adjusting the height of a crop header 14, including those described in the incorporated references.

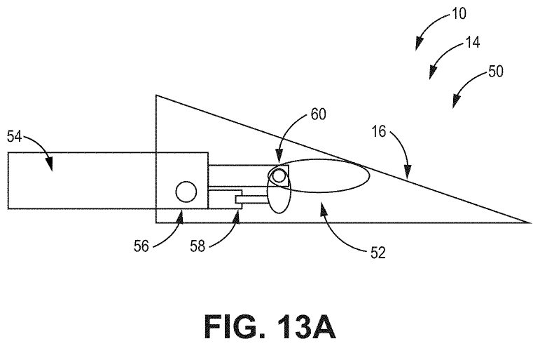

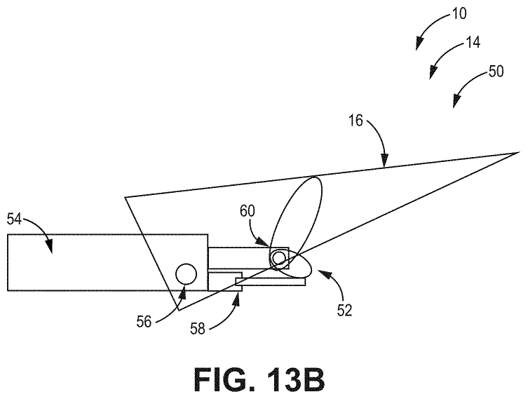

Turning to FIGS. 13A-16E, discussed herein are various implementations of a row divider adjustment mechanism 50 configured for adjusting the height, pitch, and/or angle of a row divider 16. In certain implementations, one or more actuators or winch-type mechanisms are operatively engaged with a row divider 16 to control its height, pitch and/or angle. In certain implementations, a pre-existing row divider 16 may be retrofitted or otherwise modified to be automatically or dynamically adjustable.

As shown in 13A and 13B, in certain implementations, the system 10 includes a snout 16 with a snout height stop 52 pivotally connected to a roll housing 54 or another component of the header 14 via a pivot 56. In various implementations, the adjustment mechanism 50 includes an actuator 58 mounted or otherwise affixed at the roll housing 54 or another component of the header 14. The actuator 58 may then be operatively engaged with the snout height stop 52 such that as the actuator 58 extends to the snout height stop 52 is then urged vertically about a stop pivot 60, thereby causing the snout 16 to pivot about a snout pivot 56, raising the snout 16 and increasing the distance between the snout 16 tip and the soil. As the actuator 58 is retracted the snout height stop 52 is lowered, thereby lowering the snout 16 height and decreasing the distance between the snout 16 tip and the soil.

In these and other implementations, the amount of actuator 58 extension and retraction corresponds with the degree of snout height stop 52 rotation about the pivot 60, as shown in FIGS. 13A and 13B. In various implementations, the snout height stop 52 sets a downward limit on snout 16 height, such that the snout 16 will not drop below the set point but may rotate further upward, as would be appreciated.

As would be understood, the linear actuator 58 may be electric, pneumatic, or hydraulic. In certain implementations, the actuator 58 may be integrated into or otherwise in operative communication with an electric, pneumatic, or hydraulic system on the harvester 12. In various implementations, where the corn header 14 utilizes actuators 58 to adjust the snout 16 orientation, traditional spring-loaded pin and corresponding incremental slots are not necessary or provided.

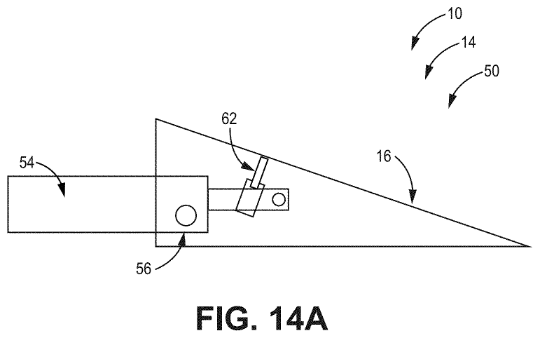

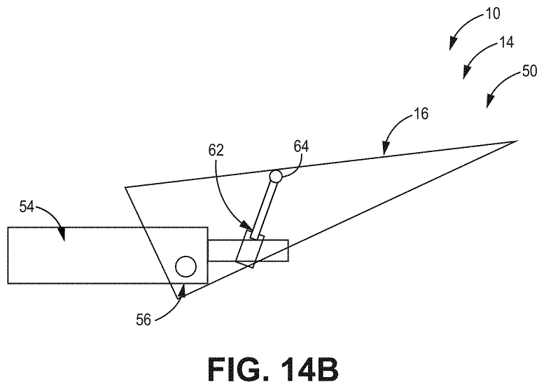

According to an alternative implementation, the adjustment mechanism 50 includes an actuator 62 configured to act directly on the snout 16, shown for example in FIGS. 14A and 14B. In these and other implementations, the amount of actuator 62 extension corresponds to the downward limit of snout 16 rotation about the snout pivot 56. In these implementations, the crop header 14 may not include a snout height stop (shown at 52 in FIGS. 13A and 13B for example) or spring-loaded adjustment pin.

In various of these implementations, a wheel 64 or other material may be attached at the end of the actuator 62 in contact with the snout 16 to reduce drag as the snout 16 slides relative to a fixed actuator 62 during extension or retraction. Various alternative mechanisms include a track and slide, a bearing, or other mechanism(s) recognized by those of skill in the art.

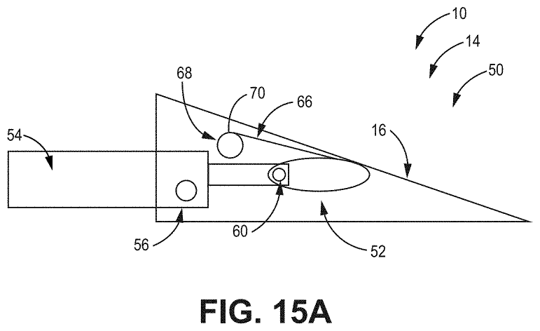

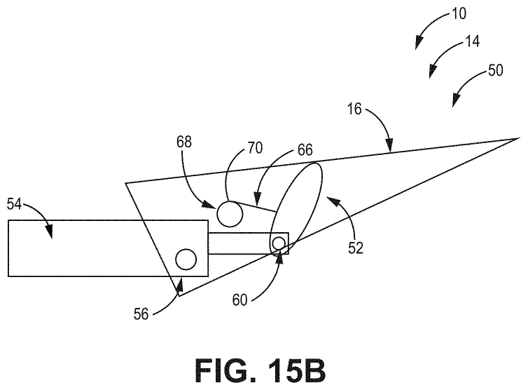

Turning now to FIGS. 15A and 15B, the system 10 and adjustment mechanism 50 may include a cable 66 and winch 68 to rotate a pre-existing or replacement snout height stop 52. In various of these implementations, an electric motor 70 is mounted in a fixed position relative to the roll housing 54. A cable 66 is attached to the motor 70 output shaft or winch 68 at one end and the snout height stop 52 on the second end. As would be understood, rotation of the motor 70 and/or winch 68 is configured to shorten or lengthen the cable 66. In various of these implementations, as the cable 66 is wound about the winch 68 the snout height stop 52 rotates about its pivot 60 thereby causes the snout 16 to be rotated about the snout pivot 56 such that the downward limit of the snout 16 rotation is increased. The opposite is also true. That is, as the motor 70 causes the cable 66 to unwind, the snout height stop 52 is lowered toward the soil which causes the snout 16 to lower such that the downward limit of the snout 16 rotation is decreased.

In these and other implementations, internal and/or external limit switches may be used to limit range of motion and prevent excessive current draw. A torsion or similar spring arrangement acting against the snout height stop 52 may be used in addition to gravity to keep the cable 66 taught.

In further alternative implementations, a lever is fixed to the motor 70 shaft. A cable 66 or other linkage is attached to the lever on one end and the snout height stop 52 on the opposing end. In these implementations, the amount of lever rotation corresponds to the degree of snout height stop 52 rotation about a pivot 60, ultimately adjusting the downward limit of snout 16 rotation about the snout pivot 56.

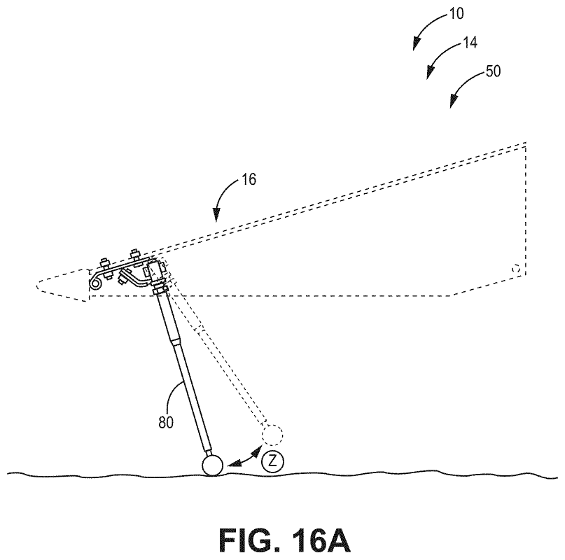

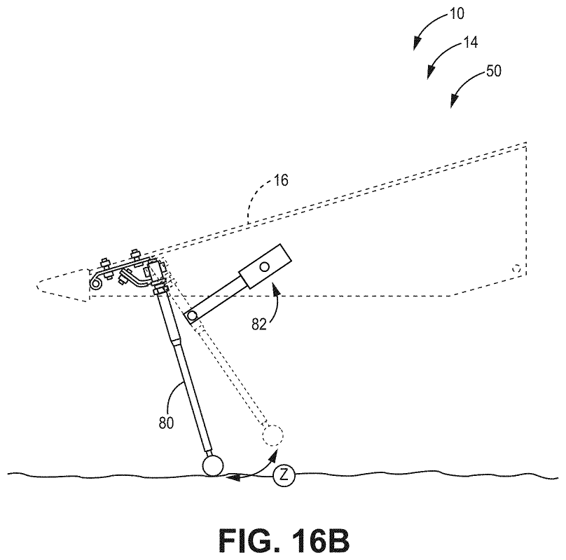

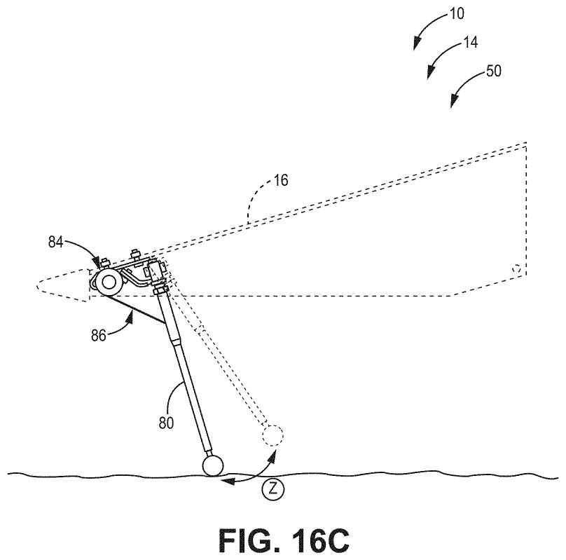

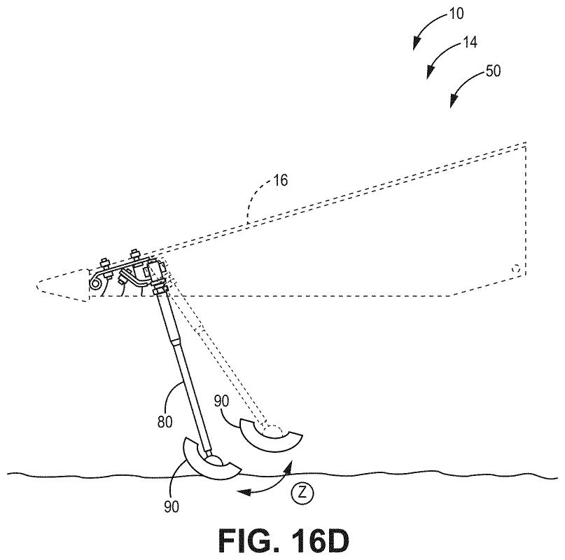

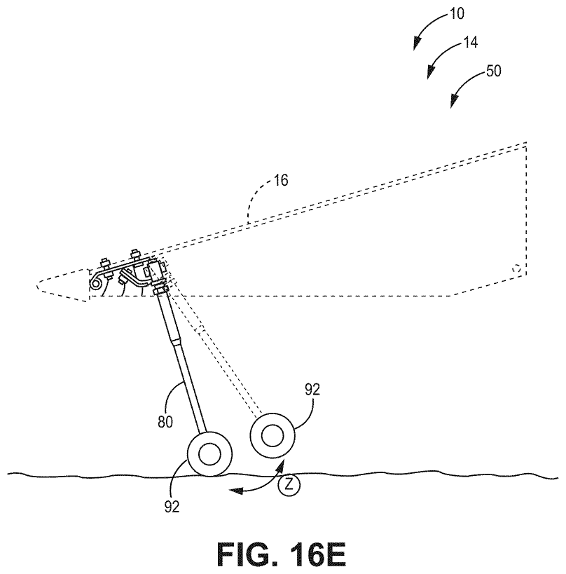

In a still further implementation, the system 10 and adjustment mechanism 50 include a ground contacting member 80 attached to the crop divider snout 16, as shown FIGS. 16A-E. In various of these implementations, the ground contacting member 80 can be extended and retracted. In an alternative implementation, the ground contacting member 80 may be rotated fore and aft (shown at reference arrow Z) thereby having the effect of adjusting the height of the crop divider 16 above the ground, shown for example in FIG. 16A.

Turning to FIG. 16B, in a further implementation, the ground contacting member 80 is rotated fore and aft (shown in at reference arrow Z) via an actuator 82. In the depicted implementation, as the actuator 82 is extended the ground contacting member 80 is urged fore or toward the tip of the snout 16. As the actuator 82 is retracted the ground contacting member 80 is urged aft or towards the body of the crop header 14. Of course, various alternative configurations of the actuator 82 are possible and would be understood by those of skill in the art. As noted above, the linear actuator 82 may be electric, pneumatic, or hydraulic and optionally integrated with a system of the harvester 12.

In another implementation, the adjustment mechanism 50 includes a winch 64 and cable 66 implemented to adjust the ground contacting member 80 position fore and aft (shown at reference arrow Z). As would be understood, a winch 84 or motor controls the length of a cable 86. The cable 86 is attached at one end to the ground contacting member 80 such that the length of the cable 86 can control the position of the ground contacting member 80. In various implementations, the winch 84 is disposed in front of the ground contacting member 80 (towards the tip of the snout 16) such that the friction created on the ground contacting member 80 via the forward travel motion of the harvester 12 keeps the cable 86 taut.

In various implementations, the ground contacting member 80 carries a portion of the weight of the snout 16. In some implementations, the ground contacting member 80 is stationary with respect to the snout 16 except when an adjustment is being made. Given these likelihoods the ground contacting member 80 may be prone to snagging on or trapping crop residue. In certain implementations, a skid 90, wheel 92, or other mechanism may be disposed on the ground contacting member 80, as shown for example in FIGS. 16D and 16E, to mitigate the effects of crop residue on the ground contacting member 80.

Turning to FIG. 16D, a shaped member 90 such as a ski 90 or skid 90 is disposed on the distal end of the ground contacting member 80. In these and other implementations, such a ski 90 or other similarly shaped member 90 may reduce the ground pressure on the ground contacting member 80 and allow the contacting member 80 to rise over crop residue instead of plowing through it or sinking into it.

In a further implementation, shown in FIG. 16E, a wheel 92, disk 92, or other rotating member 92 is disposed on the distal end of the ground contacting member 80. In various implementations, the disk 92 is a narrow disk 92 configured to cut through the crop residue. In an alternative implementation, the wheel 92 is a tire 92 configured to flatten and roll over crop residue. A variety of shapes and sizes for a rotating member 92 are possible and would be appreciated by those of skill in the art.

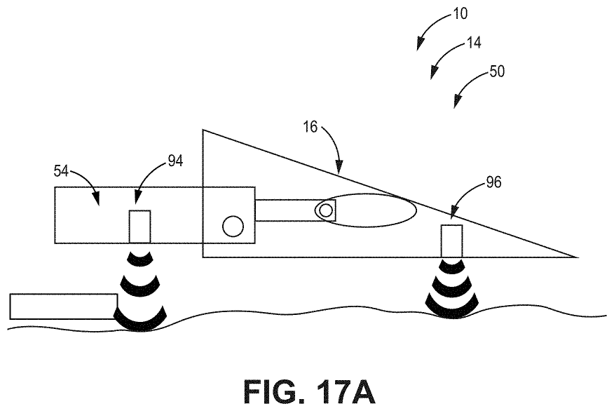

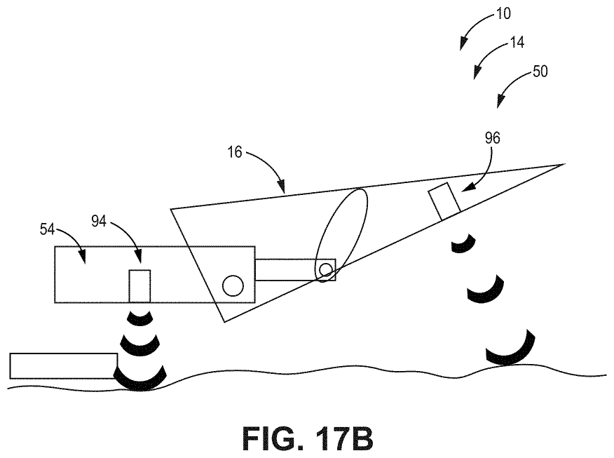

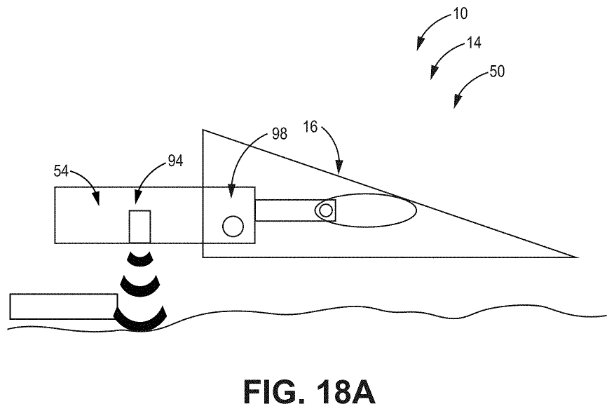

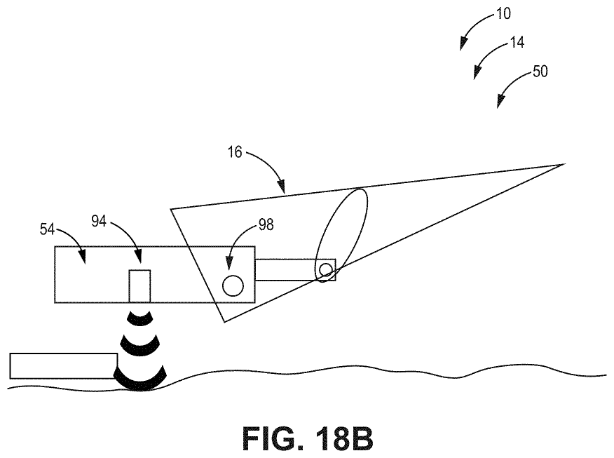

Turning to FIGS. 17A-18B, in various implementations, the system 10 adjusts the snout 16 height/angle/pitch remotely via open or closed loop control in communication with an adjustment mechanism 50. In various of these implementations, one or more height sensors 94 and/or angle sensors 98 may be implemented to control or assist in the control of the system 10.

In certain implementations, the system 10 may operate as an open loop control. That is, the system 10 may not include a snout pitch feedback sensor (as will be described further below at 96). In these and other implementations, the snout 16 height/pitch is controlled manually via a signal from an operator, such as via a display 30. An operator, optionally a person in a cab of a harvester 12 or other remote operator, can input a command to adjust the height/angle of one or more of the snouts 16.

In certain implementations, the command may be entered via a physical switch disposed within the cab of a harvester 16 or on a remote platform. The switch may be a momentary toggle switch, an increase or decrease button on a computerized user interface, such as a display 30, or other switch as would be understood by those of skill in the art.

In some implementations, all snout control mechanisms may be commanded by one master switch or button. Alternatively, more than one switch may be implemented to control an individual snout 16 or set of snouts 16. For example, the system 10 may include one switch per row divider 16. In another example, the row dividers 16 may be grouped such that one switch may control two or three or more adjacent row dividers 16.

In certain implementations, the snout 16 adjustment mechanisms are configured to move at the same rate, such that in implementations where a single switch controls more than one snout adjustment mechanism the switch will equally raise or lower the controlled snouts 16 to the same pitch.

In further implementations, the adjustment mechanisms may be equipped with a limit switch that trips when the snout 16 reaches a maximum or a minimum pitch. In these implementations, if the snouts 16 were to get out of pitch sync, such that the snouts 16 were at different heights despite being controlled by a single switch, the snouts 16 may be commanded to be pitched up or down until they reach a limit switch. Once the limit switch is reached for each snout 16, the snouts 16 will be resynchronized. Various other resynchronization methods are possible and would be appreciated by those of skill in the art.

In various implementations, the system 10 and or an operator may make on-the-go snout 16 pitch adjustments using a stalk roll shelling detection system, such as that disclosed in U.S. application Ser. Nos. 17/226,002, 17/225,586, and 17/225,740, which are incorporated by reference herein, as noted above. In these and other implementations, the system 10 or an operator may adjust snout 16 pitch in response to stalk roll shelling alarms. For example, the snout 16 pitch may be decreased or header 14 lowered until the header and/or pitch is adjusted enough that the stalk rolls stop shelling ears. Various other adaptations of this system and functionality would be recognized by those of skill in the art.

In certain implementations, the system 10 operates as a closed loop control system. In these implementations, the system 10 may automatically, continuously, or periodically make adjustments to the header 14 height and/or snout 16 pitch in response to sensor feedback.

FIGS. 17A-18B show various feedback sensors 94, 96, 98, such as, but not limited to, actuator extension/retraction sensors, snout pitch sensors, and/or ground detection snout height sensors. Ground detecting snout height sensors may be contact (also called feelers) or non-contact sensors. Non-contact sensors may be ultrasonic and/or time-of-flight IR sensors, for example. Various other sensor types are possible and would be appreciated by those of skill in the art.

As shown in FIGS. 17A and 17B, a stalk roll height sensor 94 may be disposed on the stalk roll housing 54 and constructed and arranged to determine the height between the soil surface and the stalk roll housing 54. In these implementations, a snout height sensor 96 may be disposed on the snout 16, such as toward the distal end or tip of the snout 16, although other locations are possible. The snout height sensor 96 is constructed and arranged to determine the height or distance between the ground and the snout 16. As would be appreciated, from the stalk roll height sensor 94 and the snout height sensor 96 the angle or pitch of the snout 16 can be determined.

In various implementations, the system 10 includes a snout height sensor 96 on each snout 16 enabling automatic, independent control of snout 16 height on a row-by-row basis. Specifically, the system 10 may independently adjust each snout 16 height according to a user entered target height (e.g. 3 inches), or other determined parameter as discussed herein, and the sensed position of the ground under the snout 16. In these implementations, the header 14 can automatically adjust to the ground contour.

In various alternative implementations, shown in FIGS. 18A and 18B, the system 10 may include a stalk roll height sensor 94 and a snout angle sensor 98. In these and other implementations, the snout angle sensor 96 is constructed and arranged to detect the pitch of the snout 16. In various implementations, the system 10 can determine the heights of the snout 16 tip from the stalk roll height sensor 94 and the snout angle sensor 96.

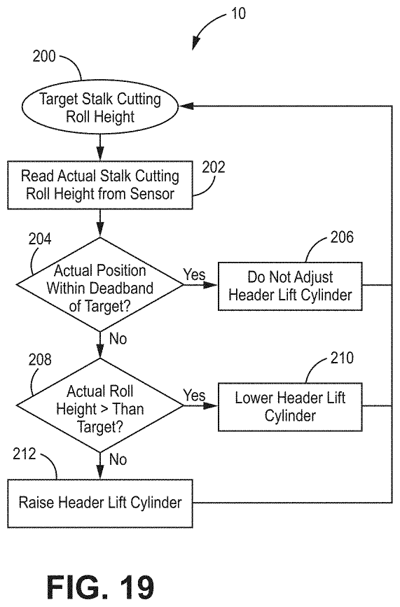

FIGS. 19-21 show various processing algorithms and/or decisions trees that may be part of the system 10. In various implementations of the system 10, various computers, processors, software, hardware, and/or firmware are constructed and arranged to carry out steps, sub-step, tasks, and commands related to calculating and adjusting the header 14 height and/or snout 16 pitch, as discussed herein. Various of the steps may be performed in any order or not at all.

FIG. 19 shows one exemplary application of the system 10 in use. In various implementations, an operator or the system 10 may set a target stalk cutting roll height (box 200). The target stalk cutting roll height (box 200) may be manually entered by an operator to a specified height. In an alternative implementation, the target stalk cutting roll height (box 200) is determined by the system 10 based on sensor data, as discussed above.

In a further optional step, the system 10 may read the actual stalk cutting roll height from a sensor 94 (box 202). The system 10 may then compare the target height (box 200) to the actual height (box 202) to determine if the actual position is within deadband of the target height (box 204). If the actual position is within deadband of the target height then no adjustment to the header height is needed (box 206). If the actual position is not within deadband of the target then the system 10 will adjust the stalk roll height.

In various implementations, the system 10 will compare the target height (box 200) to the actual height (box 202) and determine if the actual height is equal to, greater than, or less than the target height (box 208). In these implementations, if the actual stalk roll height is greater than the target height the system 10 triggers a lowering of the stalk rolls or header 14 (box 210). If the actual stalk roll height is less than the target height the system 10 raises the stalk rolls or header (box 212).

In various of these implementations, these steps are be performed in any order or not at all. In certain implementations, the steps are performed iteratively such that ongoing determinations and comparisons of pitch, height, and position are being made.

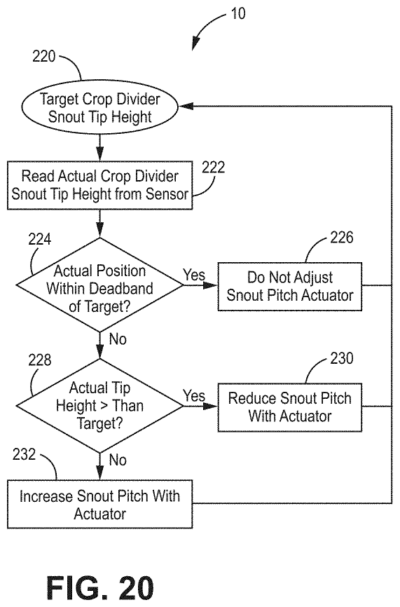

FIG. 20 depicts another exemplary algorithm. In various implementations, an operator may input a target row divider 16 tip height (box 220). In various alternative implementations, the target row divider tip height may be determined by the system 10 itself via inputs from various sensors as discussed above (box 220). In a still further implementation, the system 10 may recommend a row divider tip height that is then selected by an operator (box 220).

In a further optional step, the system 10 determines the actual row divider tip height from a sensor 82, discussed above in relation to FIGS. 17A and 17B (box 222). In an alternative implementation, the actual row divider tip height may be determined using a snout angle sensor 84, discussed above in relation to FIGS. 18A and 18B (box 222).

In another optional step, the system 10 compares the target row divider height (box 220) to the actual row divider height (box 222) to determine if the actual position is within deadband of the target (box 224). If the actual position is within deadband of the target no adjustment is made to the snout pitch (box 226). If the actual position is not within beadband of the target then an adjustment should be made to the snout pitch.

In a further optional step, the system 10 compares the target pitch (box 220) to the actual pitch (box 222) and determines if the actual pitch is greater than, less than, or equal to the target pitch (box 228). In this example, if the actual pitch is greater than the target pitch then the snout pitch should be reduced (box 230) such as via one or more of the adjustment mechanisms described above. If the actual pitch is less than the target pitch then the snout pitch should be increased (box 232) such as via one or more of the adjustment mechanisms described herein.

It would be appreciated that each of these steps is optional and may be performed in any order or not at all. Further, the various steps may be performed iteratively such as to continuously or periodically monitor and adjust the snout pitch in response to changing terrain, ground conditions and/or crop conditions.

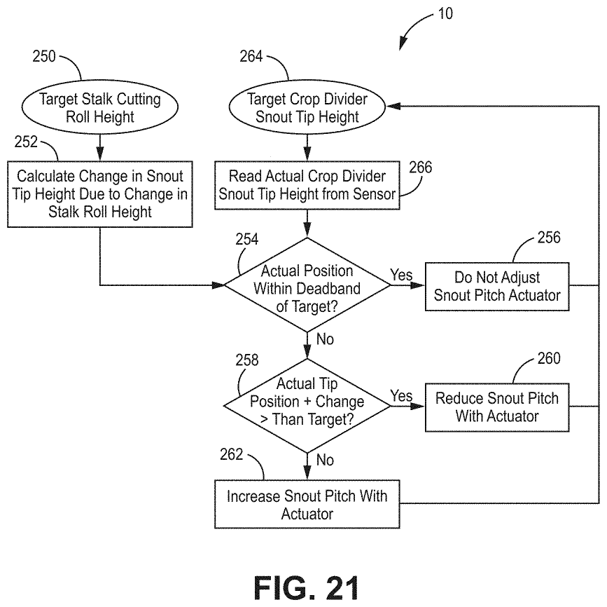

Turning now to FIG. 21, the system 10 may dynamically adjust both the header 14 or stalk roll height and the snout 16 tip height or angle/pitch. In various implementations, an operator or the system 10 enters a target header height (box 250). Further, a target row divider height may also be entered (box 264). In these and other implementations, an actual row divider height may be determined via one or more sensors (box 266), as discussed above.

In a further optional step, the system 10 may calculate the change in snout tip height due to change in the stalk roll height (box 252). The system 10 may then be constructed and arranged to determine if the actual position of the snout tip plus any change in height attributable to the header height is within deadband of the target height (box 254). If the actual height is within deadband of the target height, then no adjustment to snout pitch or header height is needed (box 256). If the actual position is not within deadband of the target height, then adjustment of the snout pitch and/or header height may be required.

In a further optional step, the actual position of the tip is compared to a target to determine if the actual position is greater than, less than, or equal to the target (box 260). If the actual position is higher than the target then the snout pitch be may be reduced (box 262), via any of the mechanisms disclosed herein or any other appreciated mechanism. If the actual position is lower than the target then the snout pitch may be increased (box 264), via any of the mechanisms disclosed herein or any other appreciated mechanism.

As noted above, the various steps may be performed in any order or not at all. Further, the various steps may be performed iteratively to allow for continuous or periodic adjustments to the snout 16 pitch and/or header 14 height. Automatic or semi-automatic adjustments to header 14 height and/or snout 16 pitch on-the-go may allow for more efficient and product harvests, leading to increased overall yields.

Although the disclosure has been described with references to various embodiments, persons skilled in the art will recognized that changes may be made in form and detail without departing from the spirit and scope of this disclosure.

What is claimed is:

1. A harvester adjustment system comprising:
(a) a database comprising one or more of rock locations, hazard locations, terrain obstacles and topography;
(b) at least one sensor configured to determine a crop condition;
(c) a processor in communication with the database and the at least one sensor;
(d) a header height adjustment mechanism in communication with the processor; and
(e) a plurality of row divider adjustment mechanisms disposed on each row divider of a harvester, in communication with the processor,
wherein the processor is configured to adjust the header height and the row divider angle based upon data from the database and sensed crop condition.

2. The harvester adjustment system of claim 1, wherein the plurality of row dividers are adjusted on a row-by-row basis.

3. The harvester adjustment system of claim 1, wherein a target header height and a target row divider position are inputted into the processor.

4. The harvester adjustment system of claim 3, further comprising a header height sensor in communication with the processor and configured to determine an actual header height.

5. The harvester adjustment system of claim 4, wherein the actual header height is compared to the target header height and the header height is adjusted so that the actual header height is within deadband of the target header height.

6. The harvester adjustment system of claim 4, wherein no adjustment to the header height is made if the actual header height is within deadband of the target header height.

7. The harvester adjustment system of claim 3, further comprising a row divider sensor in communication with the processor and configured to determine an actual row divider position.

8. The harvester adjustment system of claim 7, wherein the actual row divider position is compared to the target row divider angle and the row divider angle is adjusted so that the actual row divider position is within deadband of the target row divider position.

9. The harvester adjustment system of claim 7, wherein no adjustment to the row divider angle is made if the actual row divider position is within deadband of the target row divider position.

10. A method for adjusting harvester orientation comprising:
entering a target row divider tip height;
determining an actual row divider tip height from a row divider sensor;
comparing the actual row divider tip height to the target row divider tip height and determining if the actual row divider tip height is approximately the target row divider tip height; and
outputting a signal to a row divider adjustment mechanism to urge the row divider to an angle where the row divider tip is approximately the target row divider tip height.

11. The method of claim 10, wherein the row divider sensor is an angle sensor or a height sensor.

12. The method of claim 11, wherein the height sensor is an ultrasonic sensor or a time-of-flight sensor.

13. The method of claim 10, wherein the method is conducted iteratively and the row divider tip height is adjusted on-the-go.

14. The method of claim 10, wherein no adjustment to the row divider tip height is made if the row divider tip height is approximately the target row divider tip height.

15. The method of claim 10, wherein the target row divider tip height is based upon one or more of crop condition, ground condition, and topography.

16. The method of claim 10, further comprising:
entering a target header height into a processor;
determining an actual header height from a header height sensor;
comparing the actual header height to the target header height and determining if the actual header height is approximately the target header height; and
outputting a signal to a header height adjustment mechanism to move the header to a height that is approximately the target header height.

17. The method of claim 16, wherein the header height sensor is an ultrasonic sensor or time-of-flight sensor.

18. The method of claim 16, wherein no adjustment to the header height is made if the header height is approximately the target header height.

19. The method of claim 16, wherein the method is conducted iteratively and the header height and the row divider tip height are adjusted on-the-go.

20. A method of adjusting a row divider angle, comprising:
entering a target row divider tip height;
entering a target header height;
determining an actual row divider tip height from a row divider sensor;
determining an actual header height from a header height sensor;
comparing the actual row divider tip height to the target row divider tip height and determining if the actual row divider tip height is the target row divider tip height;
comparing the actual header height to the target header height and determining if the actual header height is the target header height; and
outputting one or more signals to a row divider adjustment mechanism and a header height adjustment mechanism to move the header and urge the row divider to positions where the row divider tip and header are at the target row divider tip height and target header height,
wherein the method is conducted iteratively and the row divider tip height and header height are adjusted on-the-go.
